(19) United States
(12) Patent Application Publication
(10) Pub. No.: US 2008/0156134 A1
(43) Pub. Date: Jul. 3, 2008

(54) Selector Slide, in Particular, for a Hydraulic Control System of a Motor Vehicle Transmission

(76) Inventor: Jorg-Uwe Habich, Bermatingen (DE)

Correspondence Address: DAVIS BUJOLD & Daniels, P.L.L.C., 112 PLEASANT STREET, CONCORD, NH, 03301, US

(21) Appl. No.: 11/908,205

(22) PCT Filed: Mar. 6, 2006
(86) PCT No.: PCT/EP2006/002008

§ 371 Date: Nov. 8, 2007

(30) Foreign Application Priority Data
Mar. 11, 2005 (DE) 10 2005 011 280.3

(51) Int. Cl. F16H 61/02

(52) U.S. Cl. 74/473.11

(57) ABSTRACT

A selector slide of the hydraulic system of a motor vehicle transmission having a reinforcing rib (1) attached such that the guide length is extended while the length of a selector slide housing (2) remains the same.

This application is a national stage completion of PCT/EP2006/002008 filed Mar. 6, 2006, which claims priority from German Application Serial No. 10 2005 011 280.3 filed Mar. 11, 2005.

### FIELD OF THE INVENTION

The present invention relates to a selector slide, in particular a selector slide of the hydraulic system of a motor vehicle transmission.

### BACKGROUND OF THE INVENTION

According to the prior art, with automatic transmissions, the motion of the shift lever is converted into a motion of a slotted disk whose motion once again results in a motion of a selector slide of the hydraulic control system. In this connection, the selector slide is mechanically actuated.

Usually the mechanical actuation of the selector slide takes place by way of an eccentrically arranged slotted disk or by way of a pin fastened in the slotted disk, which engages the slotted disk head designed as a driver head. In this connection, the rotary motion of the slotted disk is converted into translational motion of the selector slide by way of a pin which delineates a circular path.

Selector slides of this type are constructed as cast slides. The travel path of the selector slide is divided into a portion which is guided inside the housing and a portion which is unguided, outside the housing, where the length of the slide in the guided and unguided portions of the travel path change a function of the shift position.

For functional reasons, a guide lug on the selector slide may not move along the shifting path so as to be entirely out of the housing of the selector slide, because this can lead to wear and tear and edge breakage upon re-entry, since shearing forces arise on the selector slide from re-entry.

The result is that the guide for the selector slide in the selector slide housing has to be built of the corresponding length, which can be achieved by appropriately lengthening the housing and/or the selector slide. Here there arises the disadvantage that construction space is needed, which is not always available given the construction space conditions of transmissions.

The object of the present invention is to disclose a selector slide, especially a selector slide of the hydraulic control system of a motor vehicle transmission, in which the guide length is extended while the selector slide length remains constant. Moreover, no disadvantages should arise in relation to the hydraulic cross-section of the design in accordance with the invention. Furthermore, this should allow simple and economical manufacture.

### SUMMARY OF THE INVENTION

Accordingly, a selector slide, especially a selector slide of the hydraulic control system of a motor vehicle transmission, is proposed in which a reinforcing rib is installed such that the guide length is extended while the length of the selector slide remains the same.

In accordance with the invention, the cross-section of the reinforcing rib can have a cross or star shape. It can be installed with symmetrical and unsymmetrical cast selector slides.

With the design, according to the invention, the guide lug can be passed completely out of the selector slide housing. Moreover, selector slide housings can be dimensioned smaller. Within the framework of an especially advantageous further embodiment of the invention, it is recommended that the mold break of the cast structure be formed in such a way that advantageously only two mold parts are necessary for the cast structure so that manufacture of the selector slide is simple and economical.

### BRIEF DESCRIPTION OF THE DRAWINGS

The invention will now be described, by way of example, with reference to the accompanying drawings in which:

FIG. 1 is a schematic representation of a possible design of the cross-section of the reinforcing rib according to the invention;

FIG. 1A is a schematic representation of another possible design;

FIG. 2 is a schematic representation of a selector slide according to the invention with eccentric actuation;

FIG. 3 is a schematic representation of a possible mold break in the cast structure for two possible cross-sectional shapes of the reinforcing rib according to the invention, and

FIG. 3A is a schematic representation of another possible mold break in the cast structure for two possible cross-sectional shapes of the reinforcing rib according to the invention.

### DETAILED DESCRIPTION OF THE INVENTION

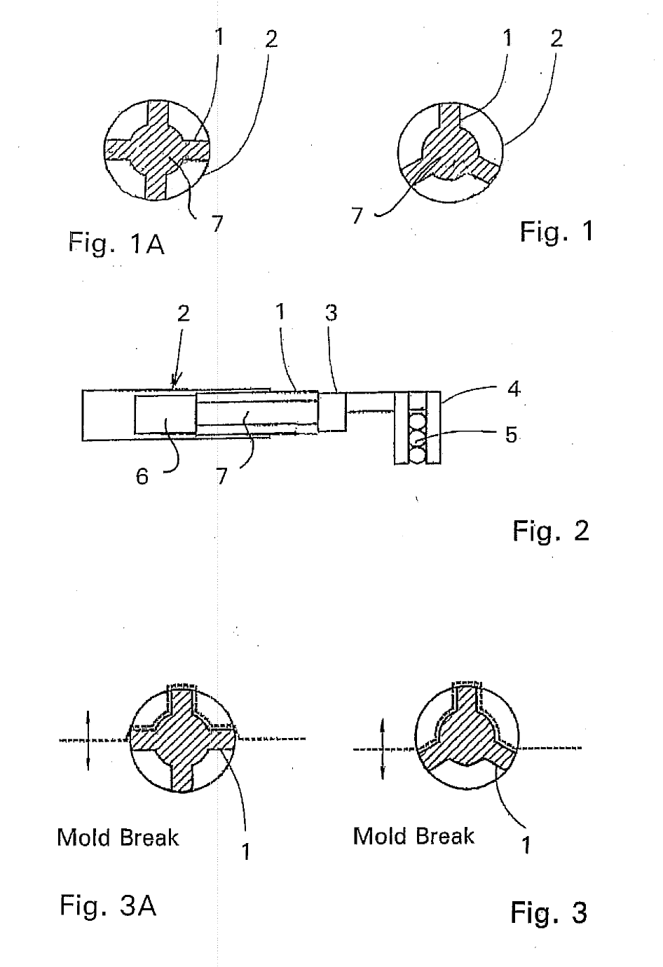

Two possible designs of a reinforcing rib 1 installed, according to the invention, are illustrated in FIGS. 1, 1A. The reinforcing rib 1 with a cross-shaped, cross-section is illustrated in FIG. 1A, and in FIG. 1, the reinforcing rib 1 with a star-shaped, cross-section is shown. A selector slide housing is designated with reference number 2.

The reinforcing rib provides guidance of a guide lug 3 outside of the housing 2. This is illustrated by FIG. 2, which shows a selector slide in which, for control, a pin 5 fastened in the transmission locking disk, engages a slide selector head 4, which is designed as a driver head.

Advantageously, the selector slide can be manufactured by way of a cast structure comprising two molding parts. A possible mold break is illustrated in FIGS. 3, 3A where the broken line separates the two molding parts. Here the reinforcing rib 1 with a cross-shaped, cross-section is shown in FIG. 3A and the reinforcing rib 1 with a star-shaped, cross-section is shown in FIG. 3.

### REFERENCE NUMERALS

1 reinforcing rib
2 selector slide housing
3 guide lug
4 selector slide head
5 pin of the locking disk

1-3. (canceled)

4. A selector slide for a hydraulic control system of a motor vehicle transmission, the selector slide being guided in a selector slide housing and including a selector slide piston and a guide lug,
wherein the selector slide has, in a region between the selector slide piston and the guide lug, one of a cross-shaped cross section and a star-shaped cross section which has supporting ribs (1) that serve to guide the selector slide in selector slide positions in which the guide lug projects out of the selector slide housing.

5. The selector slide according to claim 4, wherein the selector slide is manufactured by as cast structure which comprises two molding parts.

6. A selector slide of the hydraulic control system of a motor vehicle transmission, the selector slide comprises:
a plurality of extended reinforcing ribs (1) that extend between a selector slide piston and a guide lug,
a selector slide housing (2) which slidably guides the selector slide,
a cross section of the selector slide, between the selector slide piston and the guide lug, being one of cross shaped and star shaped, and
the selector slide housing being molded from a two piece mold.
